(19) United States
(12) Patent Application Publication
(10) Pub. No.: US 2025/0390879 A1
(43) Pub. Date: Dec. 25, 2025

(54) AUTOMATED FRAUD DETECTION USING LARGE LANGUAGE MODELS

(71) Applicant: Actimize Ltd., Ra'anana (IL)

(72) Inventors: Yonit MARCUS, Rehovot (IL); Ofir YAKOBI, Hod Hasharon (IL); Amit BEIT-NER, Ra'anana (IL)

(73) Assignee: Actimize Ltd., Ra'anana (IL)

(21) Appl. No.: 18/751,845

(22) Filed: Jun. 24, 2024

(51) Int. Cl. G06Q 20/40

(52) U.S. Cl. CPC G06Q 20/4016

(57) ABSTRACT

A device, system and method for machine-generated automatic fraud detection using a large language model to generate a human-readable summary to detect anomalies in a user's transaction history behavior. A prompt may be input into a large language model comprising a set of features of the user's current and past transactions and instructions to generate a summary explaining deviation in the user's behavior between the current and past transactions. The summary may be analyzed to detect if the deviation in the user's behavior is anomalous. When the analysis detects deviant behavior patterns between the user's current and past transactions, fraud may be suspected to automatically trigger a preventative anti-fraud action, e.g., to pre-emptive cancel, delay execution or escalate interrogation, of the current transaction.

### FIELD OF THE INVENTION

Embodiments of the invention relate to detecting anomalous transaction, such as fraud, or non-compliant transactions, using an artificial intelligence system. Embodiments of the invention more specifically relate to a system and method for automatically creating human-readable fraud detection summaries using a Large Language Model (LLM) to identify the anomalous transactions data sets.

### BACKGROUND OF THE INVENTION

Anomaly detection in transaction data sets can be a difficult task for modern intelligent systems. Anomalies in transaction data sets can represent money laundering, fraud, and/or transactions that do not comply with rules, laws, and/or regulations. However, for a particular entity, such as a bank or other financial entity, data sets for anomalies often contain little to no fraud. These commercial financial entities generally encounter lower rates of fraud or anomalous transaction than in other transaction categories, such as retail transactions. The anomalous transactions in these commercial financial data sets may be important to ensure that the entity is compliant with laws and regulations required for the entity, as well as to minimize risk and loss by the entity.

Anomalous transactions can be detected with machine learned models that trigger alerts to compliance officers. Machine learning models operate as a black box that consumes transaction data and outputs a fraud conclusion with no reason or intermediate analysis that can be understood by a human. Because this black box approach provides no human understandable insights, in order to validate machine-learned fraud alerts, a compliance officer performs an independent fraud analysis from scratch. This human-driven process is typically time consuming, error-prone and has a dependency on the level of expertise and experience of the fraud investigator. Mistakes in tagging valid alerts might lead to significant loses for an institution in the future, for example, as a false negative fraud determination might mark a user or its device as “safe,” propagating additional false positive alerts for future transactions linked to the undetected fraudster. Current fraud detection thus relies on two parallel fraud detection paths—one machine-learning driven that provides no insights and the other human driven that is error-prone—resulting in fraud detection that is inefficient and inaccurate.

Accordingly there is a longfelt need in the art for fraud detection that is efficient and accurate.

### SUMMARY OF THE INVENTION

Embodiments of the invention bridge this human-machine divide by using large language models to automatically transcribe transaction data into a human-readable summary or story to provide insights as to the reason or rational explaining deviation in the user's behavior for fraud that pre-empt the human driven fraud detection phase. Such embodiments provide human driven fraud detection phase with insight explaining the deviation for automated fraud detection alerts that was conventionally obfuscated by the black-box machine learning models. These machine-learning driven phase thus improves the human driven phase by providing compliance officers with machine-generated human-readable insights to improve speed and accuracy of their review.

The machine-generated human-readable textual summaries may additionally be transformed into vectors embedded into a n-dimensional vector space. A user's embedded vector may be compared to embedded vectors of other users historically verified to record fraudulent and/or legitimate transactions to quantify similarities therebetween, and thus quantify the risk of anomaly or fraud. The measure of fraud risk or anomalous deviation in the user's behavior may be input into a machine learning model, e.g., as a machine-learning feature, together with the user's transaction data and/or other human-readable summary features, to output a likelihood or prediction that the user's current transaction is anomalous, fraudulent or legitimate. In some embodiments, this measure of anomalous deviation in the user's behavior may be used to schedule or prioritize transactions (e.g., as a weighted factor causing transactions to be queued for compliance assessment directly proportionally to their measure of anomalous deviation in the user's behavior and non-chronologically with respect to their transaction time).

According to an embodiment of the invention, a device system and method may transform an individual user's current (recent non-historic) transaction executed by the user at a current time and each of the user's plurality of past (historic) transactions executed by the user over past (historic) period(s) of time into a set of features. A prompt may be input into a large language model comprising the user's current and past transaction features and instructions to generate a summary explaining deviation in the user's behavior between the current and past transactions. The large language model may output, and the device system and method may receive, the summary explaining deviation between the user's current transaction behavior and the user's past (historic) transaction behavior. The summary may be analyzed to detect if the deviation in the user's behavior between the current and past transactions is anomalous. When the analysis detects an above threshold deviation in the user's behavior between the current transaction and past transactions, fraud may be suspected to automatically trigger a preventative anti-fraud action. The preventative anti-fraud action may include triggering pre-emptive cancelation, delayed execution or escalated interrogation, of the current transaction.

According to an embodiment of the invention, the summary explaining deviation in the individual user's behavior generated by the large language model may be embedded into a vector in a n-dimensional vector space. The n-dimensional vector space may encode semantic meaning of the summary such that semantic similarity between the summary and another summary is proportional (e.g., linearly or non-linearly, on average or approximately) to a distance between their respective embedded vectors in the n-dimensional vector space. The distance may be measured between the individual user's summary vector and each of a plurality of vectors in the n-dimensional vector space each embedding other summaries of previously verified fraudulent or legitimate transaction events of other users (e.g., a global population of all users, or a subset of the population, such as, segment related to the target individual user whose transactions are executed on the same device or with the same account or recipient). A plurality of the other summaries for the other users may be detected embedding vectors that have a minimum or below threshold distance to the individual user's summary vector. A measure of anomalous deviation in the user's behavior between the current and past transactions may be quantified based on the distance between the individual user's summary vector and the detected plurality of the other summary vectors. A feature defining the measure of anomalous deviation in the user's behavior may be input into a machine learning model to automatically detect if the deviation in the user's behavior is anomalous. Detecting anomalous user behavior may trigger a fraud-prevention action, such as, pre-emptively canceling or delaying executing the current transaction, predicting future downstream fraudulent transactions associated with the current transaction before it is committed, altering the security requirements associated with executing the current transaction, quarantining or seizing funds or accounts associated with the current transaction, sending alert(s) to a predetermined contact comprising the measure of anomalous deviation in the user's behavior or the summary explaining deviation in the user's behavior associated with the current transaction.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart of a method for automated fraud detection using a large language model, in accordance with some embodiments of the invention;

FIG. 2 schematically illustrates an example system for automated fraud detection using a large language model, in accordance with some embodiments of the invention;

FIGS. 3-4 are flowcharts of methods for automated fraud detection using a large language model, in accordance with some embodiments of the invention;

FIGS. 5-6 schematically illustrate database storage structures of an LLM interface and a client interface of a fraud detection system, in accordance with some embodiments of the invention;

FIGS. 7A-7B depict an example table of transaction data input into a fraud detection system, in accordance with some embodiments of the invention;

FIG. 8 depicts an example prompt input into an LLM, in accordance with some embodiments of the invention;

FIG. 9A is an example of a user interface displaying an unhelpful summary, and FIGS. 9B-9C are flowcharts of methods for operating the user interface to allow users to provide feedback on the displayed summary, in accordance with some embodiments of the invention;

FIG. 10 is a flowchart of a method for optimizing LLM prompts according to user feedback on the displayed summary, in accordance with some embodiments of the invention;

FIGS. 11 and 12 are example user-interface displays of a CWI summary and a TWI summary, respectively, in accordance with some embodiments of the invention;

FIG. 13 schematically illustrates an exemplary system for automated fraud detection using a large language model, in accordance with some embodiments of the invention; and

FIG. 14 is a flowchart of a method for automated fraud detection using a large language model, in accordance with some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

Embodiments of the invention bridge the human-machine divide in fraud detection by executing a machine-driven phase using a large language model to generate transaction summaries with human-readable fraud analysis descriptions, rational and/or insights (conventionally absent from a black box ML that outputs only a fraud conclusion) to prompt a human fraud analyst to improve speed and accuracy in the human-driven phase. The human fraud analyst, and/or an automated (e.g., ML or rule-based) model, may compare the LLM-generated summary of a user's behavior with other users' behavior, for example, to detect anomalies or atypical behavior of the user. Other users' behavior may be transactions executed by the other users that are related to the user, e.g., such as those using the same or connected device(s), transacting with the same recipient(s), bank(s), account(s) and/or entit(ies), etc.).

In some embodiments, to automatically detect fraud or anomalies in the user's behavior, the summary of deviation in the user's behavior may automatically be transformed into a n-dimensional embedded vector. A measure of the user's or transaction's likelihood or risk of fraud or anomalies may be computed based on the user's summary vector's similarity to and/or difference from other n-dimensional embedded vectors of the same or other users' historically validated fraudulent and/or legitimate summaries. The measure of fraud or anomaly in the user's behavior may be based on a distance (e.g., a dot product) between the vectors, a score or ranking based on the closest fraudulent and legitimate summary vectors, a cluster proximity to fraudulent and/or legitimate summary clusters, a ML model trained to predict fraud based on these vectors, or another metric or model. In one embodiment, the measure of anomaly may be computed based on an average of distances to an integer number of (e.g., M) closest vectors in a fraudulent transaction cluster minus an average of distances to an integer number of (e.g., M) closest vectors in a legitimate transaction cluster (e.g., (Σfraud distance−legitdistance)/2). The measure of anomaly may be used to prioritize, schedule or triage review of transactions in a non-chronological order (out of the chronological order in which the transactions were executed, received or stored, e.g., reordered proportional to or weighted) based on their measures of anomaly. Additionally or alternatively, the measure of anomaly may be input (e.g., as a feature), together with other transaction data (e.g., as a set of other features), into a ML model (e.g., distinct from the LLM) to predict the likelihood that the transaction is fraudulent or legitimate. In various embodiments, fraud may be detected by a human analyst, a machine learning model, or both. Additionally or alternatively, the measure of anomaly may be used as a threshold above which (and not below which) the associated transaction(s) may be input into a ML model for automatic fraud detection, sent to a human for fraud detection, or both. Additionally or alternatively, the measure of anomaly may be used as a threshold above which (and not below which) the associated transaction(s) may be iterated for incrementally increasing levels of inspection, for example, each iteration altering the prompt to increasing levels of interrogation instructions or inputting an increasing number of a user's past transactions or case's associated transactions, such as, from a further period in the past or a greater number of associated devices or related users. For example, the multi-pass prompt process may use an nth-pass output summary metric to trigger an n+1th-pass LLM prompt iteration to further interrogate, for example, into incrementally further in the past time blocks, higher resolution of data types, more devices linked in a network to user, etc. An error metric may also be computed indicating a certainty or uncertainty of the measure of anomaly, for example, based on the stability or volatility of the instrument, LLM prediction or ML prediction, the amount or time span of the historical data, or other factors.

When an anomaly or fraud is detected, a preventative anti-fraud action may be automatically triggered. The preventative anti-fraud action may include a pre-emptive cancelation, delayed execution or escalated interrogation, of the current transaction, predicting future downstream fraudulent transactions associated with the transaction before they are committed, altering the security requirements associated with executing the transaction, quarantining or seizing funds or accounts associated with the transaction, sending fraud detection alerts to fraud enforcement, etc. Conversely, when the comparison indicates normal (non-anomalous) behavior (e.g., an above threshold similarity between the current transaction and the summary of the individual user's past behavior), the current transaction may be confirmed as legitimate to automatically trigger a signal (e.g., “Allow”) to cause the execution of the transaction, lifting holds on transactions, sending legitimate clearance alerts to fraud enforcement, etc.

Embodiments of the invention improve the efficiency and accuracy of fraud detection by automatically generating by a machine-model human-readable summaries automatically distilling salient information for their investigations, standardizing summaries to avoid confusion associated with human variety, saving significant amount of time and effort associated with manually retrieving and processing information for the summaries, and eliminating human error by generating summaries by an LLM. Embodiments of the invention improve the efficiency and accuracy of fraud detection by generating a quantified measure of fraud risk or anomaly in the user's behavior used to automatically detect fraud, to schedule or prioritize investigating transactions based on their risk score, etc. Embodiments of the invention improve the accuracy of automatic fraud detection by iteratively updating LLM prompts to generate summaries with incrementally increasing levels of inspection or transaction data resolution. Embodiments of the invention improve the security of fraud detection by encrypting, in a secure server, raw transaction data, while executing at a non-secure server operations on the encrypted transaction data, data derived from the transaction data (e.g., fraud metrics/risk scores, transaction statistics, etc.), computing layers of the LLM deeper than the initial layer (encoding transaction data) of a number of layers such that the transaction data is substantially obfuscated in those deeper layers. In some embodiments, computer devices and their memory and computational resources may be split between secure and non-secure servers allowing information that doesn't require total privacy to be offboard to devices with more resources to increase computational speed.

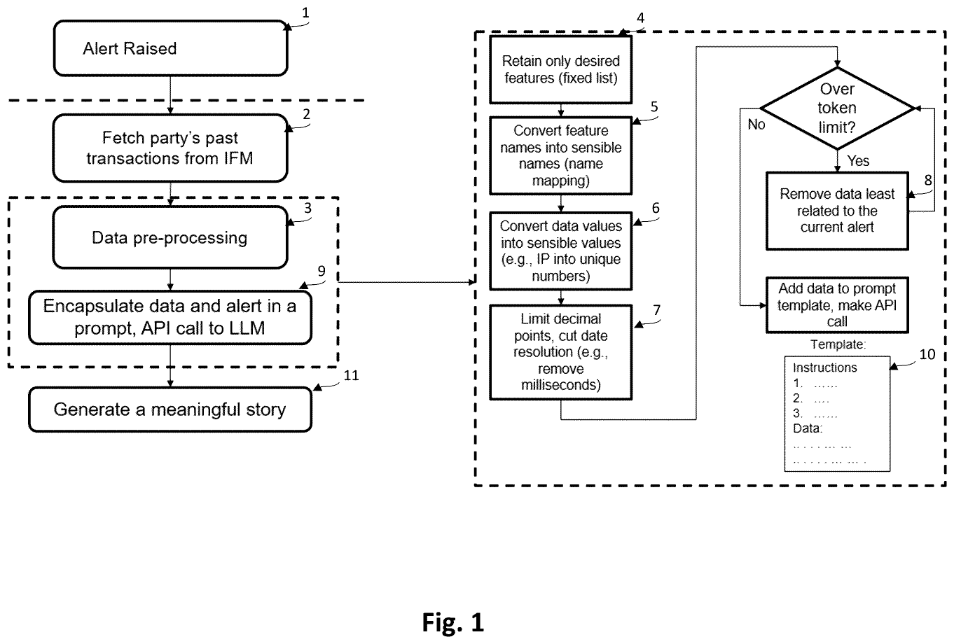

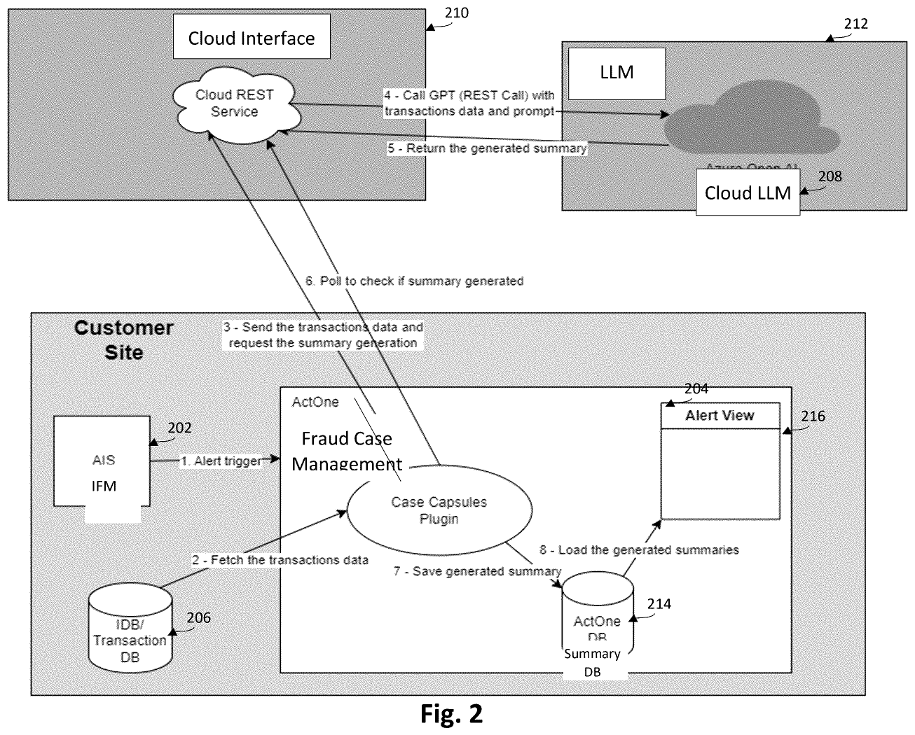

Reference is made to FIG. 1, which is a flowchart of a method for automated fraud detection using a large language model, in accordance with some embodiments of the invention.

In operation 1, a fraud detection system (e.g., customer site of FIG. 2) receives an automated fraud alert (e.g., indicating potential or likely fraud or anomalous behavior) associated with current transaction(s), device(s) and/or user(s) that triggers a machine-learning driven phase for automated fraud detection thereof.

In operation 2, the alert may cause the fraud detection system to retrieve a plurality of past transactions (including associated data) related to the current transaction(s), device(s) and/or user(s) over a past period of time.

In operation 3, the fraud detection system may pre-process the retrieved current and past transactions, for example, by extracting in operation 4 a predefined desired set of features from each of the transactions according to predefined rules (e.g., a fixed list), mapping in operations 5-6 the set of features into a uniform representation for each of the transactions (e.g., converting feature names in operation 5 and data values in operation 6 into uniform names and values), filtering in operation 7 the mapped feature representation from relatively higher resolution data to relatively compact lower resolution data (e.g., reducing decimal representations, reducing data resolution, etc.), and if the relatively lower resolution feature representation exceeds a size or token limit, decreasing its size in operation 8 (e.g., by removing its data least related to the current alert). This process involves calculating the number of tokens to be removed, but subtracting the number of token needed by the prompt, from the token limit (a known quantity that is a property of the specific LLM being used). If the token limit is exceeded, data will be trimmed based on this calculation, such that the most distant (historical?) transactions will be removed first, until the number of tokens is within the limit.

In operation 9, the fraud detection system may generate a prompt 10 for a large language model comprising data including the pre-processed compact feature representations of the transaction and instructions for the LLM to generate a summary explaining deviation in the user's behavior between the current and past transaction(s), device(s) and/or user(s).

In operation 11, the fraud detection system may receive, from the large language model, the summary explaining deviation in the user's behavior.

Reference is made to FIG. 2, which schematically illustrates an example system for automated fraud detection using a large language model, in accordance with some embodiments of the invention.

The system may include the following hardware and/or software components:

IFM (Integrated Fraud Management) system 202—An engine that processes transactions and generates alerts. IFM 202 may (1) transmit an alert associated with transaction(s), device(s) and/or user(s) to trigger a machine-learning fraud analysis thereof (e.g., as shown in FIG. 1).

Fraud case management system 204—A computing device for handling and processing the alerts. Fraud case management system 204 may receive the alert and, in response, (2) retrieve the current transaction and/or a plurality of past transactions related to the current transaction(s), device(s) and/or user(s) over a past period of time from an IDB/transaction database 206. Fraud case management system 204 may pre-process the retrieved transactions and/or generate a prompt for a large language model 208 to generate a summary of cumulative behavior of the user executing the retrieved transactions. Fraud case management system 204 may (3) send the retrieved transactions and/or the prompt to a Cloud Interface 210 to interface with a LLM system 212 large language model (LLM) 208.

Investigation Data Base (IDB)/Transaction DB 206—A database storing transactions.

Summary DB 214—a database storing alerts and/or LLM-generated summaries.

Cloud Interface 210—Hardware configured to communicate with a cloud-based LLM system 212 provider of LLM 208. Cloud Interface 210 may receive the retrieved transactions and/or prompt from fraud case management system 204 or may generate the prompt itself. Cloud Interface 210 may (4) send the retrieved transactions and/or prompt to LLM system 212.

LLM system 212—A system (e.g., local or remote, cloud-based) providing LLM 208. LLM system 212 may (5) generate and transmit a summary of cumulative behavior of the retrieved transactions based on the received prompt, such as, the transacting user's deviation in behavior between the current and past transactions.

Fraud case management system 204 may (6) poll and/or retrieve the LLM 208 generated summary and (7) store it in summary DB 214. The summary may be (8) retrieved for display on a user-interface 216 (e.g., on an analyst computer) and/or be converted into embedded vector and then input into a model for fraud detection, for example, to compare a vectorized summary for the current transaction and/or its user with other vectorized LLM-generated summaries of other users (e.g., in a general population or subset of users, such as, related user's including those using the same device, transacting with the same recipient, etc.) or the same user's behavior over different times, operating different devices or accounts, or other different samplings.

Fraud case management system 204 may execute an anti-fraud action, such as, transmitting an instruction or alert to pre-emptively cancel, override or delay the current transaction at a transaction center (e.g., a bank, market or asset exchange) when the comparison or summary indicates anomalous behavior, such as, an above threshold distance between the user's behavior vector and other user's behavior vectors verified as legitimate and/or a below threshold distance between the user's behavior vector and other user's behavior vectors verified as fraudulent or illegitimate.

Other hardware, software or configurations of devices may be used. For example, components of FIG. 2 may be combined or divided or arranged in different configurations. In one example, fraud case management system 204 may contain an internal LLM and external Cloud Interface 210 and LLM system 212 may be omitted.

Embodiments of the invention utilize Generative AI (genAI) to convert transaction data from tabular data structures into human-readable summaries or stories, and then vectorize those summaries and measure vector similarities with historical summary vectors.

Embodiments of the invention provide an LLM based pipeline in which a user's transaction history (e.g., a sequence of past transaction events) may be compared to the user's current transaction, the deviation between which may be translated into a human-readable textual story that outlines and summarized details of changes in the user's typical transaction behavior (e.g., cumulative behavior or patterns pertaining to multiple (a subset of, many or all) previous transactions). The human-readable story may be a succinct user profile of changes in the user's behavior to contrast the user's current transaction with its past transactions to detect anomalies in the user's behavior. This significantly improves case review by fraud investigators, reducing potential mistakes in tagging and/or validating fraud or anomaly alerts.

The LLM may generate a human readable summary for two levels of system alerts:
Transactional Work Item (TWI) level—i.e. transactional level alerts
Consolidated Work Item (CWI) level—i.e. case level alerts

In addition, the system may convert the textual summaries into embedded vectors (encoded representations of text that capture their essential features and semantic meaning in a high n-dimensional space, e.g., n=1024). These vectors can be utilized to measure similarities with other transactions, quantifying the similarity (or difference) to frauds and non-fraudulent transactions. Based on this analysis, the system may assign a risk score defining a measure of anomalous deviation in the user's behavior to each transaction, leveraging the similarities to predict potential fraudulence. This risk score may be presented to an analysts for human-based fraud detection and/or fed into a machine-learning model that uses this score as a feature for machine-based fraud detection. Adding the risk score as a machine-learning feature improves the accuracy of predicting fraud automatically compared to conventional machine-learning without this score.

Anti-fraud actions: When a current monetary transaction is initiated, it triggers a payment process. In this process, a user interface receives instructions for a current transaction from a user and transmits the current transaction's details to the account holder's payment system (e.g., banking or market servers) for approval. The payment system then forwards these details to the fraud detection system for risk assessment using analytical ML models and policy rules. After the fraud detection system completes the assessment, it may transmit an instruction action back to the payment system, e.g., ‘allow’, ‘decline’, or ‘delay’ the current transaction (e.g., configured as part of the policy rule creation process).

Upon receiving the action from the fraud detection system, the payment system may execute this action accordingly:
If the recommended action is ‘Allow’, the payment system approves and executes the transaction.
If the recommended action is ‘Block’, an alert may be generated. If the payment system confirms the risk, the payment system cancels the transaction, and sends a decline message to the sender. The payment system may also contact the user to notify them of the risky transaction.
If the recommended action is ‘Delay’, an alert may be generated. The payment system may pause the payment flow and contact the account holder to confirm the transaction. Only upon receiving the customer's approval, the payment system executes the transaction. If the customer does not approve, the payment system declines the transaction and labels the transaction and/or alert as ‘fraud’.

Other alerts, actions and payment system hardware and process flows may be used.

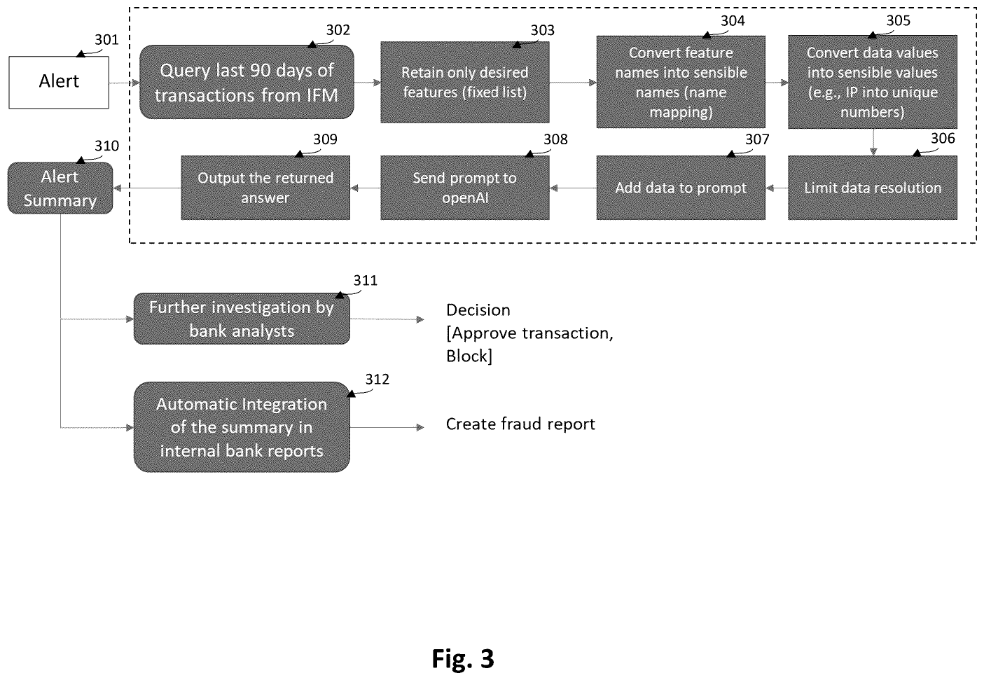

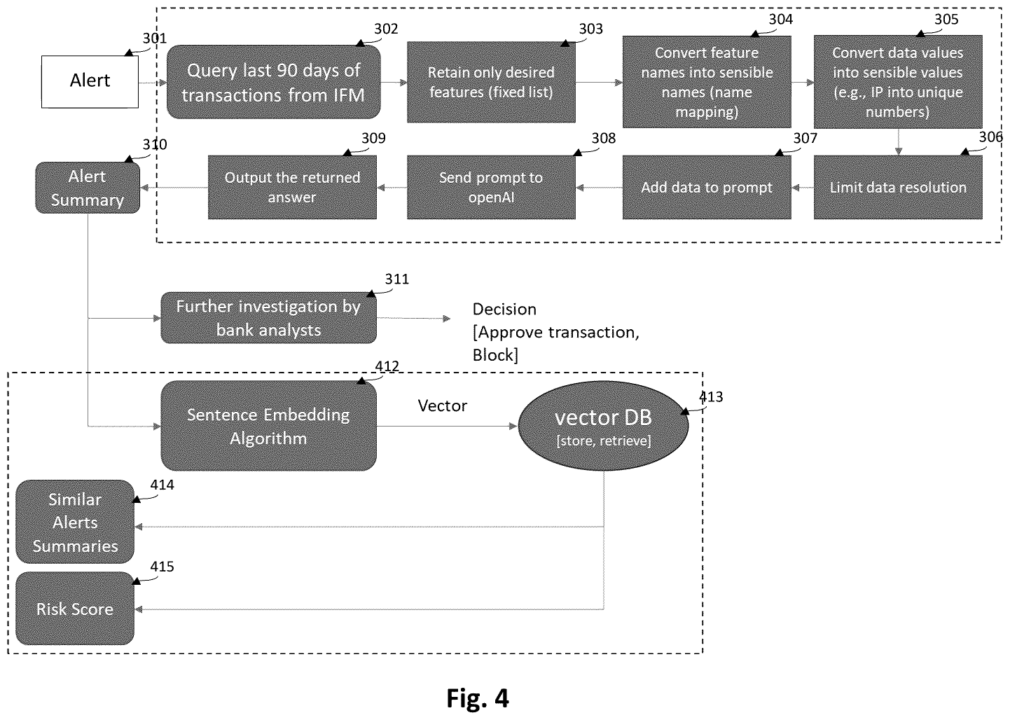

Reference is made to FIGS. 3-4, which are flowcharts of methods for automated fraud detection using a large language model, in accordance with some embodiments of the invention.

The operations of FIGS. 3-4 may be processed by executing software components using the hardware devices of FIGS. 2 and/or 13. These operations may proceed, e.g., as follows:

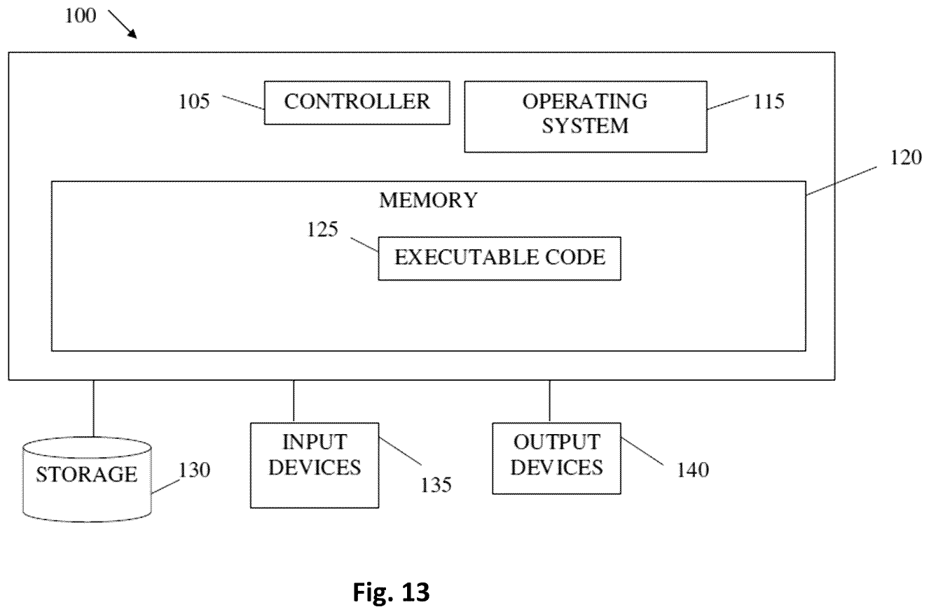

Operation 301: An alert may be generated by a fraud detection system (e.g., 204 of FIGS. 2 and/or 100 of FIG. 13). The fraud detection system may execute an API call with the following example transaction details (e.g., in JSON format):

```
{
  “transactionId”: “123456789”,
  “amount”: 100.00,
  “currency”: “USD”,
  “timestamp”: “2024-01-25T12:30:45Z”,
  “status”: “completed”,
  “sender”: {
    “accountId”: “987654321”,
    “name”: “John Doe”,
    “email”: “john.doe@example.com”
  },
  “receiver”: {
    “accountId”: “654321987”,
    “name”: “Jane Smith”,
    “email”: “jane.smith@example.com”
  }
}
```

Operation 302: The fraud detection system may send a (e.g., SQL) query to a transaction database (e.g., in an IFM (Integrated Fraud Management) system) to extract all transactions associated with a user (e.g., identified by a party identification number (ID)) as in the alert (e.g., a bank client's account number) that were executed over a predetermined past period of time (e.g., within the last 90 days).

Operation 303: Only a predetermined relevant list of features (e.g., a subset of columns of a transaction data table) may be extracted and retained, and the remaining transaction data are removed from the data table. These predetermined relevant features may be listed in an external file. In one example, this operation may be executed according to the following pseudo-code:
Read features.csv[‘features’] into an array “feature_list”;
SELECT feature_list FROM ifm WHERE party_id=‘YOUR_PARTY_ID’ AND transaction_date>=CURDATE( )−INTERVAL 90 DAY;
Save the data produced by the query in memory under “trx_data” dataframe.

Operation 304: Feature names in the extracted transaction data may be converted into predefined names recognized by the LLM. For example, the feature name “partyN” may be converted into “Client name”. This mapping is also detailed in the same file from step 3. In one example, this operation may be executed according to the following pseudo-code:
Read features.csv[‘features’] into “feature_list”, read features.csv[‘new_names’] into “new_names”. Rename each original feature name in the dataframe “trx_data” from “feature_list” to the corresponding names in “new_names”.

Operation 305: Data values in the extracted transaction data may be converted into predefined values. For example, a column that states the transaction channel may contain values like “M_P2P” may be converted into “mobile peer-to-peer transfer”. In one example, this operation may be executed according to the following pseudo-code:
Read value_mapping.csv[‘original’] into an array “original_values”, and value_mapping.csv[‘new] into an array “new_values”. Replace all original values with new values in “trx_data” dataframe.

Operation 306: Data resolution of the extracted transaction data may be reduced to generate a compact feature representation of the extracted transaction data. For example, data formats extracted at a relatively high resolution (e.g., a date up to milliseconds) may be reduced to a relatively low resolution (e.g., the date up to the day) (e.g., “11-6-2023 10:11:02.344”-->“11-6-2023”). This may reduce storage size and eliminate extraneous information to increase LLM accuracy. In one embodiment, subject matter experts (SMEs) may define the values to reduce. For example, a “transaction_date” column should store data related to the date, but not to the exact hour because it is irrelevant to fraud detection. In that case, in the code—there will be a line converting full date format into a reduced format where the hour is truncated. In one example, this operation may be executed according to the following Python code:
df[‘transaction_date’]=df[‘transaction_date’].dt.date
   The data may appear before truncation, for example, as:

| | transaction_id | party_id | amount | transaction_date |
|---|---|---|---|---|
| 0 | 1 | A123 | 100.0 | 2024-01-20 08:30:00 |
| 1 | 2 | B456 | 150.0 | 2024-01-21 15:45:00 |

The data may appear after truncation, for example, as:

| | transaction_id | party_id | amount | transaction_date |
|---|---|---|---|---|
| 0 | 1 | A123 | 100.0 | 2024-01-20 |
| 1 | 2 | B456 | 150.0 | 2024-01-21 |

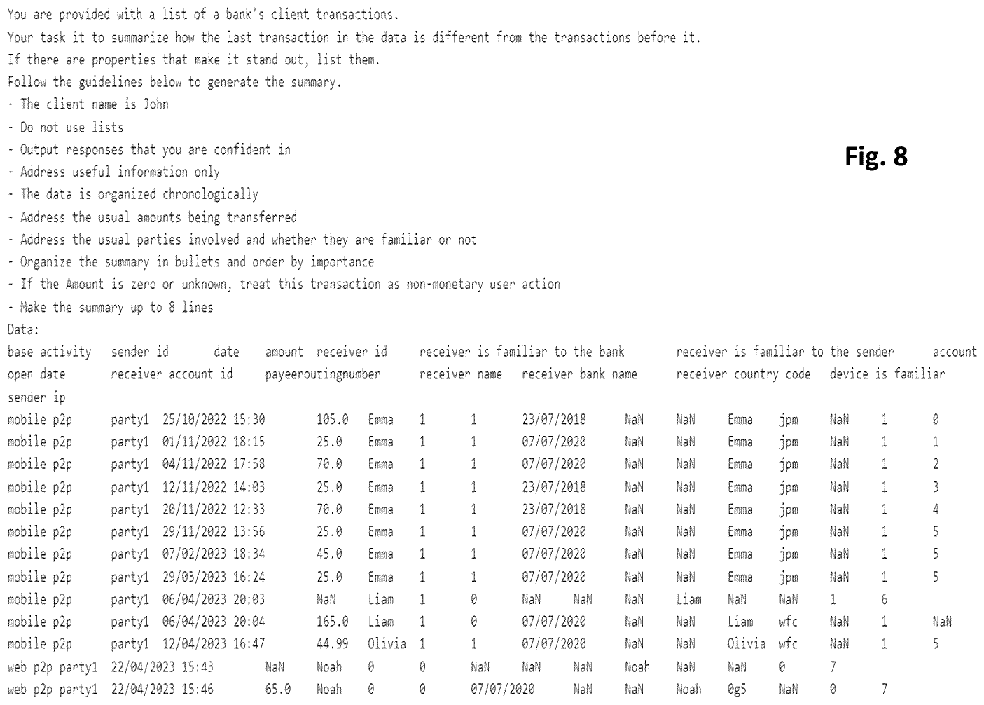

Operation 307: The processed extracted transaction data may be added to a predefined prompt (e.g., as below and/or in FIG. 8).

Operation 308: The fraud detection system sends the prompt to an LLM (e.g., 208 of FIG. 2) at an AI server (e.g., LLM system 212 via Cloud Interface 210 of FIG. 2) that returns a summary to the fraud detection system. In one example, this operation may be executed according to the following pseudo-code:

```
  import openai
  openai.api_key = api-key’
  response = openai.Completion.create(
    engine=“text-davinci-003”,
    prompt=“““
  You are a fraud analyst writing a report which summarizes recent transactions of a bank's
client.
  There is only one sender, the client, and suspicious transactions mean that the receiver,
not the sender, are possible fraudsters.
  Include the period of analysis, don't include concluding remarks or introduction.
  Be precise, use numbers to support your conclusions, and when needed provide more
details.
  Put more emphasis on details that are suspicious or seem unusual.
  Note that this list of transactions does not include all of the transactions of the client, only
the recent ones.
  Important: limit your response to 150 tokens.
  Remember to be precise and avoid an introduction or concluding remarks.
  Data:
  Transaction Base Activity: Web International Transfer
  Receiver Name: Karen Mitchell
  Transaction Date: 2023-06-01 11:13:00
  Normalized Transaction Amount: 500
  Sender ID: 852445501
  Receiver ID: I@32_1503_0045056
  Receiver is familiar to the sender: no
  Account Open Date: 2023-05-30 12:00:00
  Receiver account ID: 45056
  Receiver Bank Name: Citi Bank
  Receiver country code: BE
  Client IP: 10.546.748.23
  Receiver is familiar to the bank: no
  Device used for transaction is familiar: no
  Date the receiver was added: 2023-06-01 11:10:00
  Available Funds in the account: 3200
  Number of parties sharing the account: yes
  Number of days since the last alert triggered for this client: nan
  Number of days since the last time the client fell victim for fraud: nan
  Client Internet Service Provider name: AT&T
  Date of first Transaction to receiver by any bank client: 2023-06-01 11:11:00
  Receiver is in High Focus list: no
  The sender's Device is in High Focus list: no
  The sender's Login name is in High Focus list: no
  The sender's Email is in High Focus list: no
  Login City: New York
  Login State: New York
  ”””
  ,
    max_tokens=50
  )
  # Get the model's completion
  completion = response [‘choices'][0][‘text’]
  print(completion)
```

Operation 309: The LLM may output the textual summary of the deviation in the user's behavior between the current transaction and the past transactions.

Operation 310: The fraud detection system may generate a textual alert of the summary that may be stored (e.g., at summary database 214 of FIG. 2) and transmitted to a payment system.

Operation 311: Based on the textual alert summary, the payment system may execute anti-fraud actions and/or further investigate the transactions to make further decisions (e.g., block, approve, investigate).

In FIG. 3, Operation 312: Automatically integrate the summary into a fraud report. For example, the summary may be integrated by an external system (e.g., outside the payment system) with meta-data (e.g., date, names, etc.) of the transaction into a fraud report that is sent to stakeholders in a financial institution that monitor fraud cases. These reports, often needed by a regulator, may have the summary of the fraud case automatically generated by the LLM.

In FIG. 4, Operation 412: The summary may be input into a word embedding algorithm (e.g., SBERT) that converts the summary into a vector (e.g., a list of numbers) defining its semantic meaning, such that if this vector is a point in space, semantically similar transactions are closer to this point compared to semantically dissimilar transactions.

In FIG. 4, Operation 413: This vector may be stored in a vector database (e.g., a database for indexing and executing actions on vectors). The fraud detection system may query the vector DB for a predetermined number (e.g., five) historically validated fraudulent and/or legitimate transaction summaries that are the most semantically similar (e.g., past summaries represented by embedded vectors in the vector DB that are closest (e.g., using a distance measure such as a cosine similarity) to the vector embedding the summary of the current transaction.

In FIG. 4, Operation 414: The fraud detection system may send and display these summaries to a fraud analyst in a user interface (e.g., 216 of FIG. 2).

In FIG. 4, Operation 415: The fraud detection system may calculate an average similarity score (e.g., vector difference) of the predetermined number of fraudulent transactions, and an average similarity score (e.g., vector difference) of the predetermined number of legitimate (non-fraudulent) transactions, from the current transaction. The fraud detection system may calculate a risk score, e.g., as follows: (average of frauds similarities−average of legit similarities)/2. In one example, the risk score may be calculated and/or scaled to range from +1 (e.g., indicating a maximum likelihood of fraud/minimum likelihood of legitimacy) to −1 (e.g., indicating a minimum likelihood of fraud/maximum likelihood of legitimacy) (although any other numbers or ranges may be used). The fraud detection system may present this risk score to the fraud analyst to assist with the decision and may input this risk score as a feature into an automatic fraud detection ML model to enhance fraud prediction capabilities.

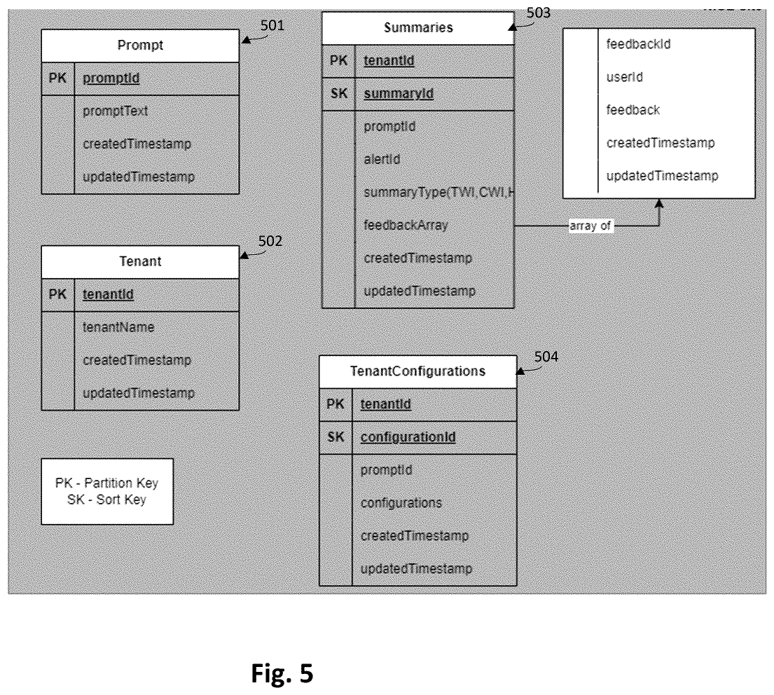

Reference is made to FIG. 5, which schematically illustrates a database storage structure of an LLM interface (e.g., cloud interface 210 of FIG. 2), in accordance with some embodiments of the invention. The database storage structure of FIG. 5 may store the following example data:

Prompt data 501 may include the text itself of an LLM prompt and prompt meta data (e.g., time of prompt creation and time of a prompt update if any update was performed).

Tenant data 502 may include a tenant name e.g., of a financial institution.

Summaries 503 may include data of the prompt, summary LLM output, feedback and/or time.

Tenant configuration 504 may include data related to software configuration for the specific tenant.

Other LLM interface database storage structures and data may also be used.

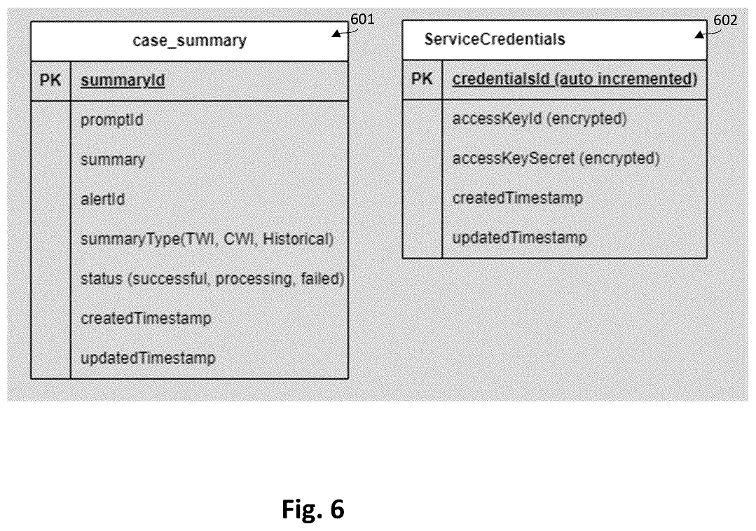

Reference is made to FIG. 6, which schematically illustrates a database storage structure in a client interface of a fraud detection system (e.g., 204 of FIG. 2), in accordance with some embodiments of the invention. The database storage structure of FIG. 6 may store the following example data:

Each current transaction that triggers an alert (e.g., 301 of FIG. 1 from IFM 202 of FIG. 2) causes the fraud detection system to receive from a transaction database (e.g., 206 of FIG. 2) all or a subset of the user's past transactions over a predetermined time period (e.g., prior 90 days) (e.g., including the current alerted transaction). The data structure of the received transaction data depends on the data structure of the transaction database. In one example, the received transaction data includes up to 50 features for each transaction event. Features may be application specific and stored as a list of features that may include, for example, characteristic of the sender (such as Account Open Date, Available Balance), characteristic of the beneficiary (Receiver Bank Name, Receiver Name, a Boolean flag that marks whether isReceiverFamiliarToSender, etc.) as well as raw properties of the transaction (such as amount). The tabular data may be translated into sentences by converting the features names to their descriptors and may be inserted into the LLM prompt. Example transaction features stored at the client interface database for insertion into the LLM prompt include:

601: A prompt identification (ID), an alert ID (connecting the alert and the summary), and the summary data.

602: Credentials to communicate with external devices in the fraud detection system.

Other client interface database storage structures and data may also be used.

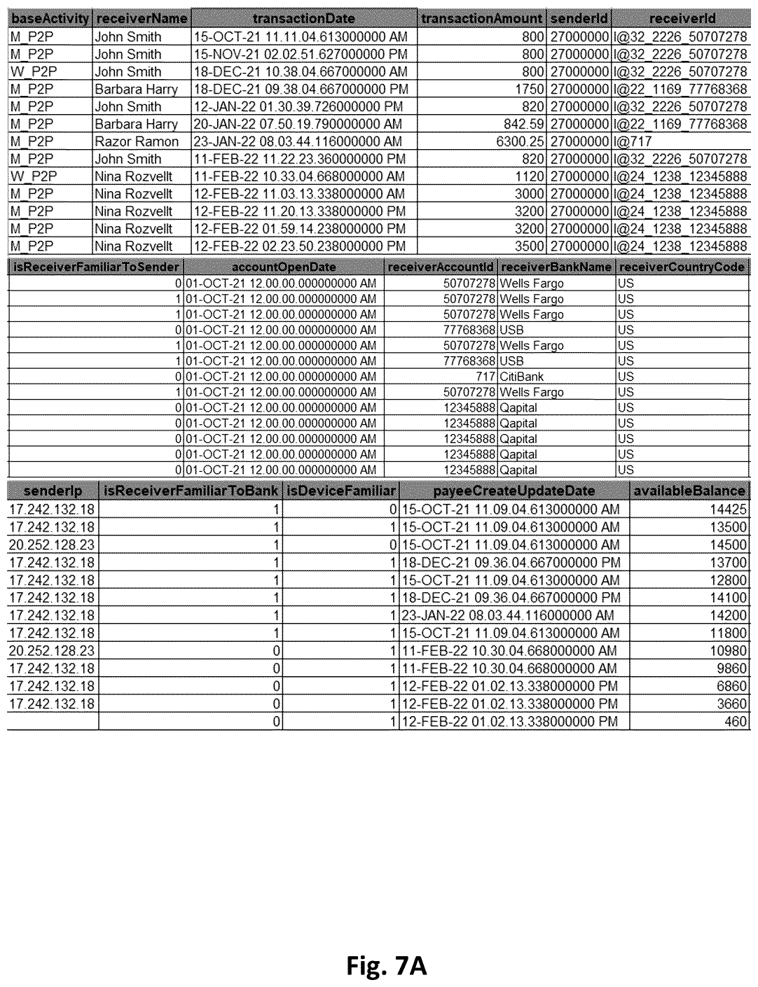

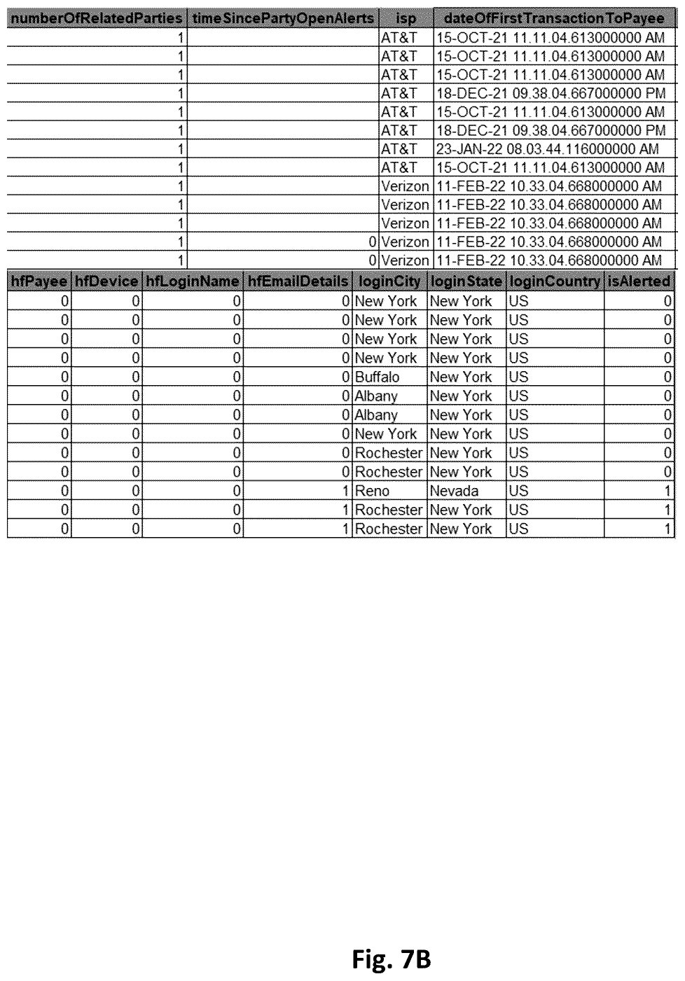

Reference is made to FIGS. 7A-7B, which is a table of example transaction data input into the fraud detection system (e.g., 204 of FIG. 2), in accordance with some embodiments of the invention. The transaction data of FIGS. 7A-7B includes 13 transactions received from a transaction database (e.g., 206 of FIG. 2) associated with a CWI (case level) alert that triggers the fraud detection system to determine if there is case level fraud. In response to inputting the transaction data of FIGS. 7A-7B, the fraud detection system may execute a fraud detection process (e.g., as shown in FIGS. 3-4) to generate an output summary of the case, for example, as follows: “The current CWI includes 3 transactions (WI_0000000196, WI_0000000199, WI_0000000200) related to Refname (sender id 27000000). The three transactions share several suspicious indicators. All were peer-to-peer transfers made by the same client (sender ID 27000000) to an unfamiliar receiver, Nina Rozvellt. The transactions were made on the same day, Feb. 12, 2022, with significant amounts relative to the sender's account balance, indicating medium risk. The receiver's bank, Qapital, is considered unusual, adding another layer of medium risk. The client's email is on the high focus list in all transactions, indicating high risk. Unresolved previous alerts associated with the client further increase the risk level. The transactions were conducted from familiar devices via Verizon ISP, but the geo-location discrepancies and bursts in new payee activity raise additional concerns.” Additionally or alternatively, the fraud detection system may generate an output summary of the recent transaction history of the client, for example, as follows: “The data includes transactions from Oct. 15, 2021 to Feb. 12, 2022. The client has made transactions to four different receivers: John Smith (5 transactions), Barbara Harry (2 transactions), Nina Rozvellt (2 transactions), and Razor Ramon (1 transaction). The client has sent the most money to Razor Ramon ($6300.25), followed by Nina Rozvellt ($4120.00), John Smith ($4040.00), and Barbara Harry ($2592.59). None of the transactions were flagged as suspicious. Half of the transactions were to receivers not familiar to the sender, and two transactions were to receivers not familiar to the bank. In two transactions, the device used by the client was not familiar.” A user-interface (e.g., 216 of FIG. 2 on an analyst computer) may display an alert summary (e.g., 310 of FIGS. 3-4) comprising either or both of these summaries and/or indicating anomalous, suspicious or fraudulent activity.

Reference is made to FIG. 8, which is an example prompt input into an LLM (e.g., 208 of FIG. 2), in accordance with some embodiments of the invention. In response to inputting the prompt of FIG. 8 into the LLM, the LLM may output the following example summary: “The last transaction was made through the web platform, while previous transactions were made through mobile p2p. The receiver, Noah, is not familiar to the bank or the sender, unlike previous transactions with familiar receivers. The transaction amount of 65.0 is not within the usual range of 25.0, 45.0, or 70.0 seen in previous transactions. The receiver's bank name, 0g5, is different from the usual jpm and wfc seen in previous transactions. The device used for the last transaction is not familiar, while previous transactions were made using familiar devices. The sender IP for the last transaction is different (7) from the IPs used in previous transactions (0-6).”

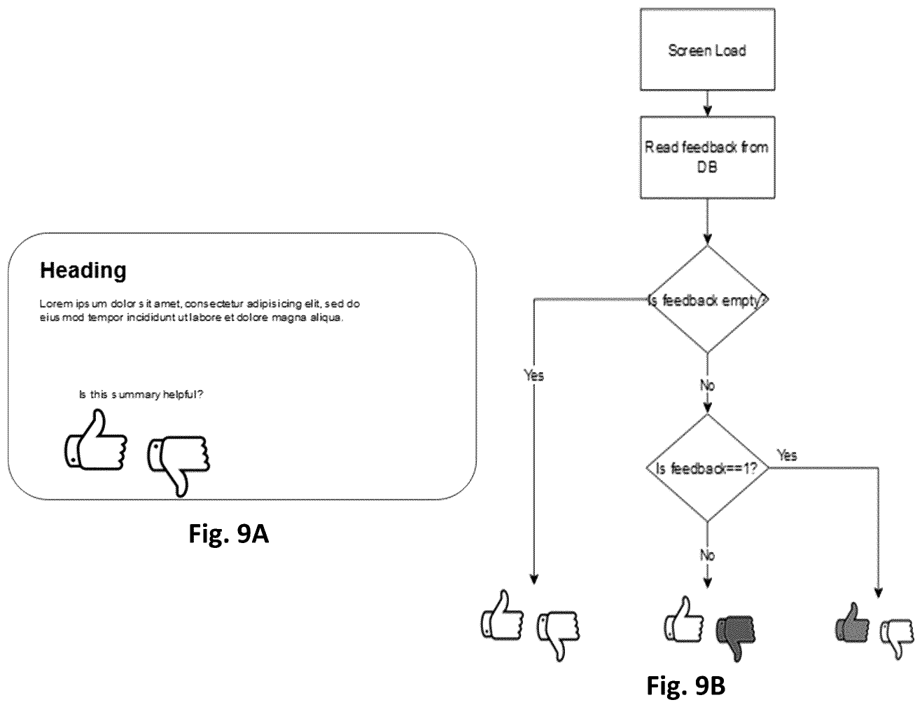

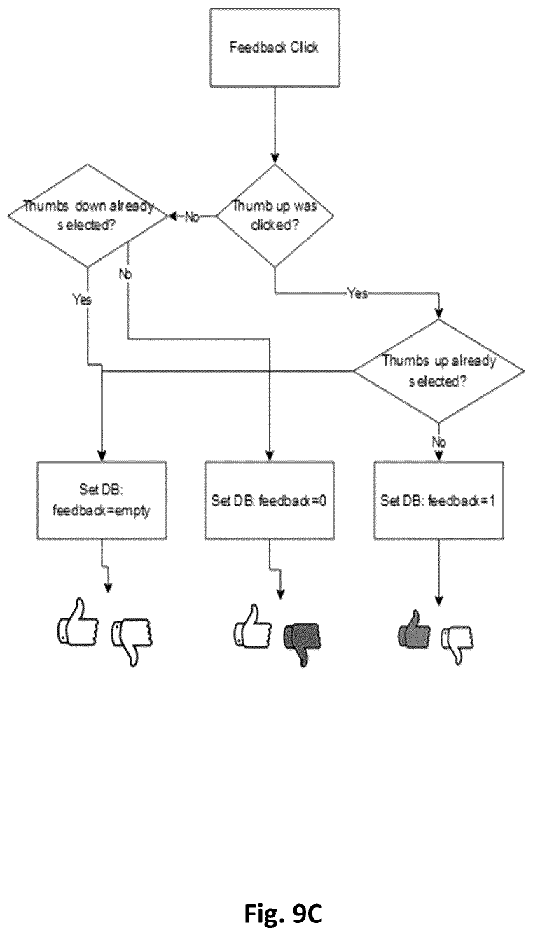

Reference is made to FIG. 9A, which is an example of a user interface displaying an unhelpful summary, and FIGS. 9B-9C which are flowcharts of methods for operating the user interface to allow users to provide feedback on the displayed summary, in accordance with some embodiments of the invention. The user-generated feedback may be stored in a database (e.g., 214 of FIG. 2). Feedback may be collected as follows:

The method of FIG. 9B loads a feedback icon indicating a user's feedback (e.g., green thumbs up or red thumbs down icon) on the user interface as follows:
1. After the initial screen has been loaded with the summary, present thumbs up and down.
2. Load feedback from database.
3. If feedback is not set (feedback is null), display empty (e.g., white) thumbs (no feedback given yet).
4. If feedback is “Yes” (positive feedback), display thumbs up as green and thumbs down as empty.
5. Else, If feedback is “No” (negative feedback), display thumbs down as red and thumbs up as empty.

The method of FIG. 9C records feedback selections indicating a user's feedback (e.g., green thumbs up or red thumbs down icon) via the user interface as follows:
1. If feedback is “Yes” (positive)
   a. If current feedback is “Yes”, set feedback to null.
   b. Else, set feedback to “Yes”
2. If feedback is “No” (negative)
   a. If current feedback is “No”, set feedback to null.
   b. Else, set feedback to “No”

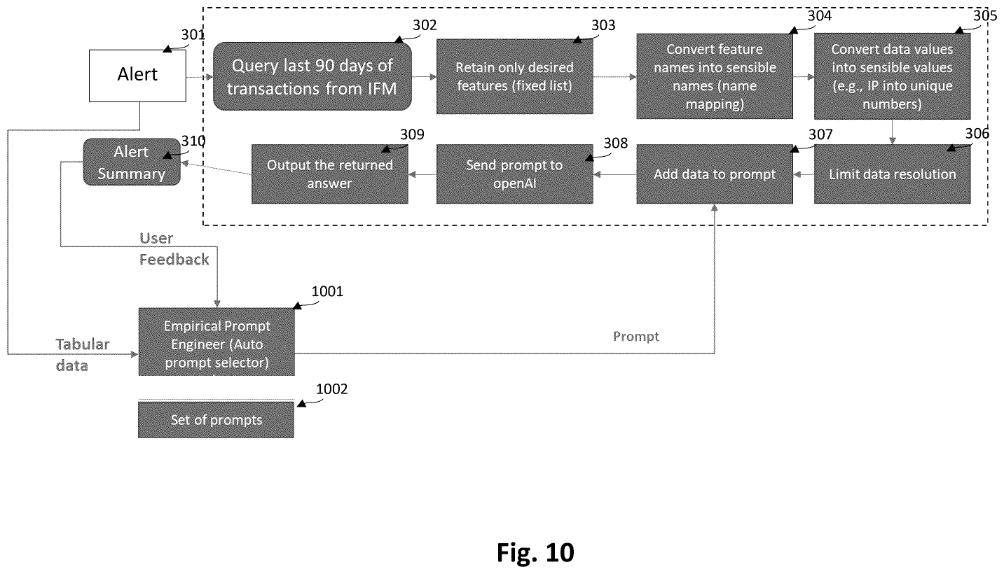

Reference is made to FIG. 10, which is a flowchart of a method for optimizing LLM prompts according to user feedback on the displayed summary, in accordance with some embodiments of the invention. Operations in the dotted box may be executed as described in reference to FIGS. 3-4, the remainder of which may proceed as follows:

Operation 1001: User feedback, e.g., along with transaction (such as, tabular) data may be sent to an empirical prompt engineer (EPE). The EPE includes a set of multiple prompts 1002, and selects an optimal prompt (e.g., maximizing the probability of positive user feedback) based on the transaction data. The EPE may operate as disclosed in U.S. application Ser. No. 18/585,203 filed on Feb. 23, 2024, which is incorporated by reference herein in its entirety. The selected feedback-optimized prompt may be sent to the fraud detection system in operation 307 to be integrated with the processed transaction data to generate a consolidated prompt to send to the LLM in operation 308 as described in reference to FIGS. 3-4 above.

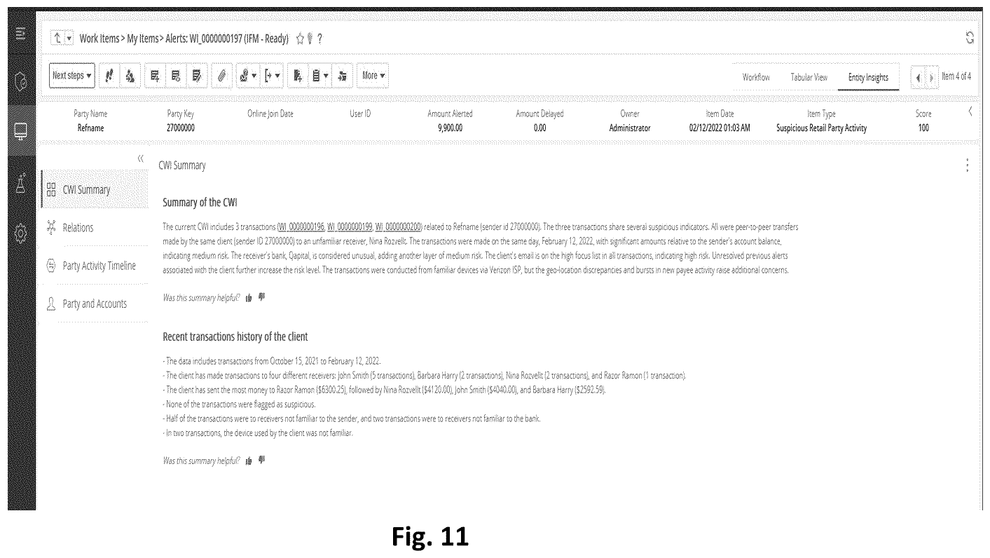

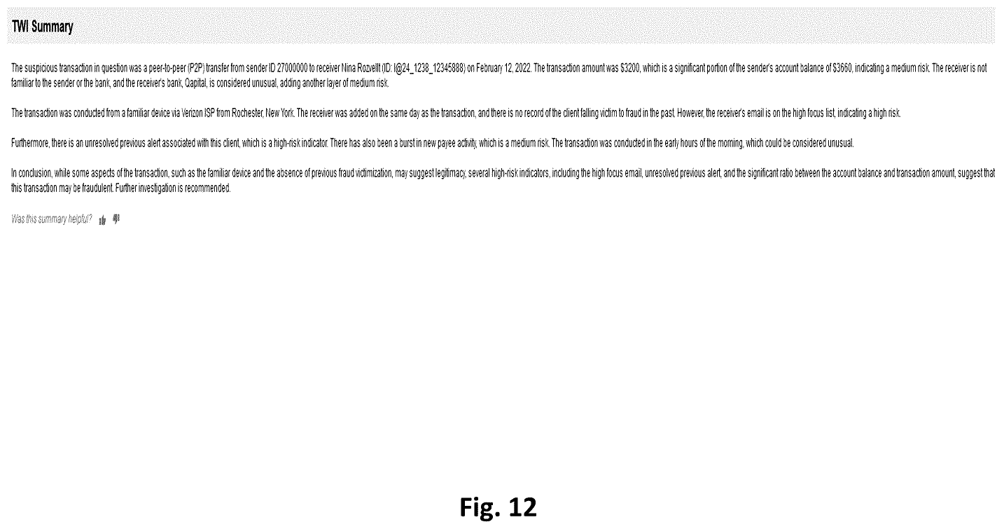

Reference is made to FIGS. 11 and 12, which are example user-interface displays of a CWI summary and a TWI summary, respectively, in accordance with some embodiments of the invention. In the CWI level, which consolidates TWIs, the summary may be located on the right side of an Entity Insights tab within an CWI view (although other display arrangements may be used).

Reference is made to FIG. 13, which schematically illustrates an exemplary system for automated fraud detection using a large language model, in accordance with some embodiments of the invention.

Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system. Each data structure, programming code, algorithm, and/or equipment discussed herein may be or include, or may be executed by, a computing device such as included in FIG. 13, although various units among these may be combined into one computing device.

Operating system 115 may be or may include code to perform tasks involving coordination, scheduling, arbitration, or managing operation of computing device 100, for example, for automated fraud detection using a large language model (e.g., as described in reference to FIGS. 1-12 and 14). Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or data such as low-level action data, output data, etc.

Executable code 125 may be any application, program, process, task or script. Executable code 125 may be executed by controller 105 possibly under control of operating system 115. For example, executable code 125 may be one or more applications performing methods as disclosed herein (e.g., as described in reference to FIGS. 1, 3-4, 9B-9C, 10 and 14). In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a Compact Disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices, which may be operated by for example a compliance officer (e.g., for providing user feedback via user interface as described in reference to FIGS. 9A-9C). Output devices 140 may include one or more displays, speakers and/or any other suitable output devices or combination of output devices (e.g., for depicting a display of an LLM-generated summary on user-interface 216 of FIG. 2 or FIGS. 11-12, or depicting a display of a user feedback interface as described in reference to FIGS. 9A-9C). Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

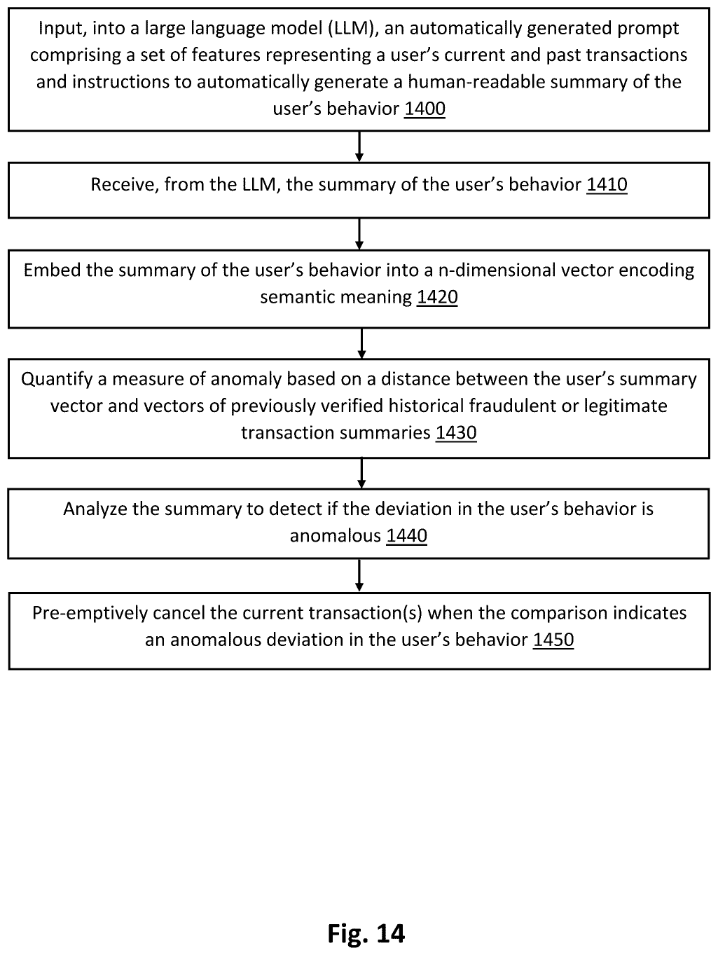

Reference is made to FIG. 14, which is a flowchart of a method for automated fraud detection using a large language model, in accordance with some embodiments of the invention. Operations described in reference to FIG. 14 may be executed using devices described in reference to FIGS. 2 and/or 13 (e.g., device 100 using one or more processor(s) such as controller 105 of FIG. 13).

In operation 1400, one or more processor(s) may input, into a large language model (LLM), an automatically generated prompt comprising set of features representing a user's current transaction, past transactions and instructions to automatically generate a human-readable summary explaining deviation in the user's behavior between the current transaction and the past transactions. The one or more processor(s) may automatically generate the prompt (e.g., as described in reference to FIGS. 3-4) by retrieving the user's past transactions associated with one or more events performed by the user over a past period of time, extracting a set of features from each of the plurality of transactions according to predefined rules, mapping the set of features into a uniform representation for each of the plurality of transactions and filtering the mapped feature representation from relatively higher resolution data to relatively compact lower resolution data, and inserting the filtered compact lower resolution feature representation into a prompt, together with instructions to generate the summary of user behavior. The prompt may be fixed, dynamically selected from among a plurality of prompts to maximize user feedback, or dynamically automatically adjusted based on a separate LLM prompted to write prompt instructions and/or based on a rules-based process.

In operation 1410, one or more processor(s) may receive, output from the LLM, the summary of the user's behavior (deviation between the user's current and past transactions) in the summary.

In operation 1420, one or more processor(s) may embed the summary of the user's behavior into a vector in a n-dimensional vector space, wherein the n-dimensional vector space encodes semantic meaning of the summary such that semantic similarity between the summary and another summary is proportionally (e.g., linearly or non-linearly, on average or approximately) related to a distance between their respective embedded vectors in the n-dimensional vector space.

In operation 1430, one or more processor(s) may quantify a measure of anomaly or fraudulent/legitimate behavior in the user's behavior based on the distance between the user's summary vector and each of a plurality of vectors in the n-dimensional vector space each embedding other summaries (of the same or other users) of previously verified fraudulent or legitimate transaction events. In some embodiments, the other summaries represent a predefined equal number of the previously verified fraudulent and the previously verified legitimate transaction events. For example, the measure of anomaly in the user's behavior may be based on a fraud average of the distances between the user's summary vector and the vectors embedding the other summaries of previously verified fraudulent transaction events minus a legitimate average of the distances between the user's summary vector and the vectors embedding the other summaries of previously verified legitimate transaction events. In some embodiments, the one or more processor(s) may schedule or prioritize current transaction(s) in a queue or buffer for fraud detection based on the measure of anomaly in the user's behavior and in non-chronological order with respect to their respective transaction times.

In operation 1440, one or more processor(s) may analyze the summary to detect if the deviation in the user's behavior between the current and past transactions is anomalous. This analysis may involve inputting, into a machine learning model (ML), a set of features representing the user's current transaction(s) and the measure of anomaly in the user's behavior to automatically predict a likelihood that the current transaction(s) are anomalous, fraudulent or legitimate. Current transaction(s) may be requested, initiated, executed, received and/or stored in a recent (not historic) time period (e.g., in real-time, within the past minute or up to an hour), whereas past or historic transaction(s) may be requested, initiated, executed, received and/or stored in a significantly past (historic) time period (e.g., not in real-time, and after the past minute or after an hour) and/or may be transaction(s) that were already analyzed for fraud (e.g., processed in a previous iteration as a current transaction in operation 1440).

When the analysis of operation 1440 indicates an anomalous deviation in the user's behavior between the current and past transactions (e.g., the measure of anomaly is within a high fraud range), the one or more processor(s) may proceed to operation 1450; otherwise the one or more processor(s) may confirm as legitimate or terminate processing the current transaction(s) of the present iteration and iterate to operation 1400 with a new (e.g., more recent or next queued or buffered) current transaction(s).

In operation 1450, one or more processor(s) may pre-emptively cancel, interrupt or delay the execution of the current transaction(s). One or more processor(s) of a transaction system, having previously (e.g., prior to operation 1400) received an instruction to trigger initiating a transaction program for the current transaction(s) may subsequently (in operation 1450) receive an instruction stop, block or override the transaction to trigger the one or more processor(s) to terminate the transaction program for the current transaction(s). Additionally or alternatively, the one or more processor(s) may execute another preventative anti-fraud action, for example, predicting future downstream fraudulent transactions associated with the transaction before they are committed, altering the security requirements associated with executing the current transaction(s), quarantining or seizing funds or accounts associated with the current transaction(s), sending fraud detection alert(s) associated with the current transaction(s) to fraud enforcement, etc. A multi-level alert system may send the fraud detection alert(s) including a transaction level alert defining potential fraudulent or legitimate behavior associated with a single current transaction of the user, and/or a consolidated level alert defining potential fraudulent or legitimate behavior associated with multiple current transactions of the user.

Additional or different operations may be used, operations may be excluded, and different orders of operations may be used.

Embodiments of the invention although described primarily in terms of single transaction-level (TWI) fraud analysis may equally, with appropriate adjustment, apply to multiple transaction case-level (CWI) fraud analysis. Embodiments of the invention although described primarily to refer to behavior of a single user may equally, with appropriate adjustment, apply to multiple users (e.g., a team or linked group, such as, in a family, company or sharing a location).

Embodiments of the invention although described primarily to detecting fraudulent transaction(s), apply equally to detecting legitimate transaction(s), detecting a level of fraudulence or legitimacy, detecting a degree, metric or score of fraudulence or legitimacy, detecting anomalous, suspicious or atypical behavior.

Human-readable may refer, for example, to a textual description in a human written and spoken language, such as, English, Chinese, etc. (contrasted with a computer-language, such as, C++, meant to be read and processed by a computer).

Embodiments of the invention may improve the technologies of computer automation, machine learning, computer bots, big data analysis, and computer use and automation of fraud detection by using specific algorithms to analyze large pools of data, a task which is impossible, in a practical sense, for a person to carry out in real-time. Embodiments may more effectively, quickly and accurately identify fraudulent or suspicious transactions in real-time to pre-empt and prevent fraud.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method for fraud detection, the method comprising:
inputting, into a large language model, a prompt comprising a set of features representing a current transaction associated with the user at a current time, a plurality of past transactions associated with the user over a past period of time and instructions to generate a summary explaining deviation in the user's behavior between the current transaction and the past transactions;
receiving, from the large language model, the summary explaining deviation in the user's behavior between the current and past transactions;
analyzing the summary to detect if the deviation in the user's behavior between the current and past transactions is anomalous; and
pre-emptively canceling or delaying the execution of the current transaction when the analysis detects an anomalous deviation in the user's behavior between the current and past transactions in the summary.

2. The method of claim 1, wherein analyzing comprises:
embedding the summary explaining deviation in the user's behavior between the current and past transactions into a vector in a n-dimensional vector space, wherein the n-dimensional vector space encodes semantic meaning of the summary such that semantic similarity between the summary and another summary is proportionally related to a distance between their respective embedded vectors in the n-dimensional vector space; and
quantifying a measure of anomalous deviation in the user's behavior between the current and past transactions in the summary based on the distance between the user's summary vector and each of a plurality of vectors in the n-dimensional vector space each embedding other summaries of the same or other users previously verified fraudulent or legitimate transaction events.

3. The method of claim 2, wherein the other summaries represent a predefined equal number of the previously verified fraudulent and the previously verified legitimate transaction events.

4. The method of claim 2, wherein the measure of anomalous deviation in the user's behavior is based on a fraud average of distances between the user's summary vector and the vectors embedding the other summaries of previously verified fraudulent transaction events minus a legitimate average of distances between the user's summary vector and the vectors embedding the other summaries of previously verified legitimate transaction events.

5. The method of claim 2 comprising inputting a feature defining the measure of anomalous deviation in the user's behavior into a machine learning model to output a likelihood that the current transaction is a fraudulent or legitimate transaction.

6. The method of claim 2 comprising, upon detecting the measure of anomalous deviation in the user's behavior is within a range associated with high fraud potential, executing a fraud-prevention action selected from the group consisting of: predicting future downstream fraudulent transactions associated with the current transaction before it is committed, altering the security requirements associated with executing the current transaction, quarantining or seizing funds or accounts associated with the current transaction, sending alert(s) to a predetermined contact comprising the measure of anomalous deviation in the user's behavior or the summary explaining deviation in the user's behavior associated with the current transaction.

7. The method of claim 2 comprising scheduling transactions for fraud detection based on the measure of anomalous deviation in the user's behavior and in non-chronological order with respect to the transaction times of the scheduled transactions.

8. The method of claim 1 comprising automatically generating the prompt by:
retrieving the current and past transactions associated with the user;
extracting the set of features from each of the current and past transactions according to predefined rules;
mapping the set of features into a uniform representation for each of the current and past transactions;
filtering the mapped feature representation from relatively higher resolution to relatively lower resolution; and
inserting the relatively lower resolution feature representation, together with the instructions to generate the summary explaining deviation in the user's behavior between the current transaction and the past transactions, into the prompt.

9. The method of claim 1 comprising, when the comparison indicates an anomalous deviation, a multi-level alert system sends an alert comprising:
a transaction level alert defining potential fraudulent or legitimate behavior associated with the single current transaction of the user; and
a consolidated level alert defining potential fraudulent or legitimate behavior associated with multiple of the current transactions of the user or related users.

10. A system comprising:
one or more memories configured to store a current transaction associated with the user at a current time and a plurality of past transactions associated with the user over a past period of time; and
one or more processors configured to:
input, into a large language model, a prompt comprising a set of features representing the current transaction associated with the user at a current time, the plurality of past transactions associated with the user over a past period of time and instructions to generate a summary explaining deviation in the user's behavior between the current transaction and the past transactions,
receive, from the large language model, the summary explaining deviation in the user's behavior between the current and past transactions,
analyzing the summary to detect if the deviation in the user's behavior between the current and past transactions is anomalous, and
pre-emptively cancel or delay the execution of the current transaction when the analysis detects an anomalous deviation in the user's behavior between the current and past transactions in the summary.

11. The system of claim 10, wherein the one or more processors are configured to analyze comprising:
embedding the summary explaining deviation in the user's behavior between the current and past transactions into a vector in a n-dimensional vector space, wherein the n-dimensional vector space encodes semantic meaning of the summary such that semantic similarity between the summary and another summary is proportionally related to a distance between their respective embedded vectors in the n-dimensional vector space, and
quantify a measure of anomalous deviation in the user's behavior between the current and past transactions in the summary based on the distance between the user's summary vector and each of a plurality of vectors in the n-dimensional vector space each embedding other summaries of previously verified fraudulent or legitimate transaction events.

12. The system of claim 11, wherein the other summaries represent a predefined equal number of the previously verified fraudulent and the previously verified legitimate transaction events.

13. The system of claim 11, wherein the measure of anomalous deviation in the user's behavior is based on a fraud average of distances between the user's summary vector and the vectors embedding the other summaries of previously verified fraudulent transaction events minus a legitimate average of distances between the user's summary vector and the vectors embedding the other summaries of previously verified legitimate transaction events.

14. The system of claim 11, wherein the one or more processors are configured to input a feature defining the measure of anomalous deviation in the user's behavior into a machine learning model to output a likelihood that the current transaction is a fraudulent or legitimate transaction.

15. The system of claim 11, wherein the one or more processors are configured to, upon detecting the measure of anomalous deviation in the user's behavior is within a range associated with high fraud potential, execute a fraud-prevention action selected from the group consisting of: predicting future downstream fraudulent transactions associated with the current transaction before it is committed, altering the security requirements associated with executing the current transaction, quarantining or seizing funds or accounts associated with the current transaction, sending alert(s) to a predetermined contact comprising the measure of anomalous deviation in the user's behavior or the summary explaining deviation in the user's behavior associated with the current transaction.

16. The system of claim 11, wherein the one or more processors are configured to schedule the current transaction for fraud detection based on the measure of anomalous deviation in the user's behavior and in non-chronological order with respect to the transaction times of the scheduled transactions.

17. The system of claim 10, wherein the one or more processors are configured to automatically generate the prompt by:
retrieving the current and past transactions associated with the user,
extracting the set of features from each of the current and past transactions according to predefined rules,
mapping the set of features into a uniform representation for each of the current and past transactions,
filtering the mapped feature representation from relatively higher resolution to relatively lower resolution, and
inserting the relatively lower resolution feature representation, together with the instructions to generate the summary explaining deviation in the user's behavior between the current transaction and the past transactions, into the prompt.

18. The system of claim 10, wherein, when the comparison indicates an anomalous deviation, the one or more processors are configured to send a multi-level alert including:
a transaction level alert defining potential fraudulent or legitimate behavior associated with the single current transaction of the user; and
a consolidated level alert defining potential fraudulent or legitimate behavior associated with multiple of the current transactions of the user or related users.

19. A non-transitory computer-readable storage medium storing instructions, which when executed by one or more processors, cause the one or more processors to:
input, into a large language model, a prompt comprising a set of features representing a current transaction associated with the user at a current time, a plurality of transactions associated with a user over a past period of time, and instructions to generate a summary explaining deviation in the user's behavior between the current and past transactions;
receive, from the large language model, the summary explaining deviation in the user's behavior between the current and past transactions;
analyze the summary to detect if the deviation in the user's behavior between the current and past transactions is anomalous; and
pre-emptively cancel or delay the execution of the current transaction when the analysis detects an anomalous deviation in the user's behavior between the current and past transactions in the summary.

20. The non-transitory computer-readable storage medium of claim 19 storing instructions, which when executed by one or more processors, further cause the one or more processors to:
embed the summary explaining deviation in the user's behavior between the current and past transactions into a vector in a n-dimensional vector space, wherein the n-dimensional vector space encodes semantic meaning of the summary such that semantic similarity between the summary and another summary is proportionally related to a distance between their respective embedded vectors in the n-dimensional vector space; and
quantify a measure of anomalous deviation in the user's behavior between the current and past transactions in the summary based on the distance between the user's summary vector and each of a plurality of vectors in the n-dimensional vector space each embedding other summaries of previously verified fraudulent or legitimate transaction events.
